(19) United States
(12) Patent Application Publication
(10) Pub. No.: US 2017/0174902 A1
(43) Pub. Date: Jun. 22, 2017

(54) DUAL STAGE CURED ACRYLIC COMPOSITIONS AND RELATED METHODS

(71) Applicant: Avery Dennison Corporation, Glendale, CA (US)

(72) Inventors: Thomas C. EPPLE, Madison, OH (US); Robert MEDSKER, Avon, IN (US)

(21) Appl. No.: 15/127,591

(22) PCT Filed: Mar. 20, 2015
(86) PCT No.: PCT/US15/21696

§ 371 Date: Sep. 20, 2016

Related U.S. Application Data
(60) Provisional application No. 61/968,425, filed on Mar. 21, 2014.

(51) Int. Cl. C09D 4/06; C08J 3/28; C08J 3/24; C08F 220/06; C09D 133/02

(52) U.S. Cl. CPC C09D 4/06; C08F 220/06; C09D 133/02; C08J 3/24; C08J 3/28; C08J 2333/02

(57) ABSTRACT

Various methods involving a sequential, dual stage cure are described. The methods utilize a first stage UV cure which is sequentially followed by a second stage electron beam cure. An array of compositions are also described, many of which are acrylate based.

### CROSS-REFERENCE TO RELATED APPLICATION

The present application claims the benefit of U.S. Provisional Application No. 61/968,425 filed Mar. 21, 2014, which is incorporated herein by reference in its entirety.

### FIELD

The present subject matter relates to acrylic compositions that are curable via a dual stage curing process. The present subject matter also relates to various methods of processing and manufacturing using dual stage curing. Additionally, the present subject matter also relates to polymeric materials at least partially cured via a dual stage curing process.

### BACKGROUND

In certain applications, it is desirable to provide acrylic materials which exhibit a relatively high shear strength, generally referred to in the art as “high shear.” Although high shear materials can be formed from solvent-containing acrylic compositions, such high shear characteristics are particularly difficult to achieve from solvent-free acrylic compositions.

Accordingly, a need exists for methods and compositions that enable high shear materials to be formed from solvent-free acrylic compositions.

### SUMMARY

The difficulties and drawbacks associated with previously known compositions and processes are addressed in the present compositions and methods.

In one aspect, the present subject matter provides a method of forming a cured polymeric material. The method comprises providing a polymeric composition. The method also comprises exposing the composition to ultraviolet (UV) radiation to thereby form an intermediate composition. And, the method additionally comprises exposing the intermediate composition to electron beam (EB) radiation to thereby form a cured polymeric material.

In another aspect, the present subject matter provides a method of forming a cured polyacrylate material. The method comprises providing an acrylic composition including: (i) at least one low molecular weight polymer, (ii) at least one monomer diluent, (iii) acrylic acid, and (iv) at least one photoinitiator. The method also comprises subjecting the acrylic composition to ultraviolet (UV) radiation to at least partially cure the composition and thereby form an intermediate composition. And, the method comprises subjecting the intermediate composition to electron beam (EB) radiation to thereby form a cured polyacrylate material.

In yet another aspect, the present subject matter provides a radiation curable acrylic composition. The composition comprises (i) at least one low molecular weight acrylic polymer, (ii) at least one monomer diluent, (iii) acrylic acid, and (iv) at least one photoinitiator.

In still another aspect, the present subject matter provides a polymeric material that is at least partially cured by sequential exposure to ultraviolet (UV) radiation followed by exposure to electron beam (EB) radiation.

As will be realized, the subject matter described herein is capable of other and different embodiments and its several details are capable of modifications in various respects, all without departing from the claimed subject matter. Accordingly, the description is to be regarded as illustrative and not restrictive.

### DETAILED DESCRIPTION OF THE EMBODIMENTS

The present subject matter relates to a multiple stage, and particularly a two stage, curing process for radiation cured acrylic polymers and compositions. The process includes an operation of (i) a first cure operation using UV radiation, sequentially followed by (ii) a second cure operation using electron beam (EB) radiation. The compositions of the subject matter that can be employed in the various methods generally comprise (i) one or more low molecular weight polymer(s), (ii) one or more monomer diluents, (iii) acrylic acid, and (iv) photoinitiator(s). The compositions may also comprise optional crosslinkers. In certain embodiments, the compositions do not include and thus are free of solvents that are typically used in corresponding acrylic compositions.

Table 1 set forth below, lists typical and particular proportions (expressed in weight percentages based upon the total weight of the composition) of components in the present subject matter compositions.

TABLE 1
Solvent-Free Acrylic Compositions

| Component | Typical Amounts | Particular Amounts |
|---|---|---|
| Low Molecular Weight Polymer(s) | 0.1-90% | 10-90% |
| Monomer Diluent(s) | 0.1-90% | 10-90% |
| Acrylic Acid | 0.1-50% | 5-30% |
| Photoinitiator(s) | 0.5-10% | 1-8% |
| Crosslinker(s) | 0-10-% | 1-8% |

It will be appreciated that the proportions noted above in Table 1 are representative and do not limit the present subject matter. In addition, it will also be understood that the present subject matter includes compositions which contain one or more components in addition to those set forth in Table 1. In certain versions of the present subject matter, the compositions only contain one or more low molecular weight polymers, one or more monomer diluents, acrylic acid, and one or more photoinitiators with optional crosslinker(s). Moreover, the present subject matter includes compositions that contain solvent or relatively low amounts of solvent. If the composition contains solvent, it is contemplated that such solvent will be removed or at least substantially removed prior to the dual stage curing as describe herein. Details as to each of the components noted in Table 1 are as follows.

### Low Molecular Weight Polymer

The compositions of the present subject matter generally comprise a low molecular weight polymer and particularly a low molecular weight acrylate polymer. Typically, the low molecular weight polymer and particularly one or more low molecular weight acrylate poymer(s) are crosslinkable. A wide variety of crosslinkable acrylate polymers and/or that can be used and are known in the polymer and adhesive arts. Generally, suitable acrylic polymers and/or copolymers are capable of undergoing a crosslinking polymerization reaction with themselves or other polymerizable compounds to form a three-dimensional structure. The acrylate polymer and/or copolymer typically includes at least one radiation-curable functional group. Radiation-curable functional groups include any of those known in the art. Specifically, the radiation curable functional groups may be groups reactive via cationic mechanisms such as epoxy groups. Examples of these include glycidyl acrylate or methacrylate. Groups with allylic and oxetane functionality are also examples of radiation-curable functional groups that are reactive via cationic mechanisms. Radiation-curable functional groups can also include free radical function groups such as groups that have acrylate or methacrylate functionality.

In certain embodiments of the present subject matter, the acrylate polymers and/or copolymers may include a comonomer selected from the group consisting of acrylamide, acrylonitrile, acrylic add, alpha-methyl styrene, butyl acrylate ethyl acrylate, n-butyl acrylate, 2-ethylhexyl acrylate, glycidylmethacrylate, 2-hydroxyethylmethacrylate, hexyl acrylate, hydroxyethyl acrylate, isobornyl acrylate, isobutyl acrylate, isooctyl acrylate, isodecyl acrylate, isononyl acrylate, methacrylic acid, methyl acrylate, methacrylonitrile, n-vinyl caprolactam, nonyl acrylate, caprolactam, propyl acrylate, tert-butyl acrylate, vinyl acetate, vinyl pyrrlidone, styrene, and combinations thereof.

In certain embodiments of the present subject matter, the crosslinkable acrylate polymer and/or copolymer includes a comonomer comprising ethyl acrylate, 2-ethylhexyl acrylate, methyl acrylate, vinyl acetate and combinations thereof.

In still other embodiments, the crosslinkable acrylate polymer and/or copolymer includes a benzophenone-functionalized acrylic copolymer, and particularly a benzophenone-functionalized solvent-free acrylic copolymer comprising 2-ethylhexyl acrylate or butyl acrylate comonomer. In still yet other embodiments, the crosslinkable acrylate polymer and/or copolymer is a solvent-free crosslinkable benzophenone-functionalized acrylate copolymer which includes a copolymer comprising 2-ethylhexyl acrylate or butyl acrylate comonomer.

### Monomer Diluents

The compositions according to the present subject matter may comprise one or more monomer diluents. Typically, the monomer diluent may be included in the composition to adjust the viscosity of the composition. In addition, the same or different monomer diluents may be added to the composition to form the final or cured composition with a property value within a specified target value range. Thus, monomer diluents typically include compounds that tend to effect at least one property value of the composition and/or contain at least one functional group capable of polymerization when exposed to actinic radiation. In certain embodiments, the monomer diluent may include one or more radiation-curable functional groups. Radiation-curable functional groups include any of those known in the art. Specifically, the radiation curable functional groups may be groups reactive via cationic mechanisms such as epoxy groups, Examples of these include glycidyl acrylate or methacrylate. Groups with allylic and oxetane functionality are also examples of radiation-curable functional groups that are reactive via cationic mechanisms. Radiation-curable functional groups can also include free radical function groups such as groups that have acrylate or methacrylate functionality.

The monomer diluent of the present subject matter compositions is selected to be one that is compatible with the low molecular weight polymer. Depending on the particulars of the composition, this may mean that the radiation-curable functional group present on the monomer diluent is the same or different than that used in the low molecular weight polymer. In certain embodiments, the radiation-curable functional group present in the monomer diluent is capable of copolymerizing with the functional group present on the low molecular weight polymer. Monomer diluents with ethylenic unsaturation (including, for example, acrylate, methacrylate and/or vinyl) can be used in certain embodiments. In particular, acrylate unsaturation is used.

The monomer diluent is added in such an amount that the viscosity of the composition is in the range of about 1,000 to about 10,000 mPa·s. The amount of monomer diluent present in the composition will range from 0.10 to 90 wt. %, more typically the amount will between 10 and 90 wt. %, particularly between 20 and 80 wt. %, and more particularly, between 30 and 70 wt. %.

Depending on the parameters of the specific composition, any suitable monomer diluent may be used, including some lower weight oligomers. Suitable acrylate monomers include for example: C2-C18 hydrocarbondioldiacrylates C4-C18 hydrocarbondivinylethers C3-C18 hydrocarbontrioltriacrylates, the polyether analogs thereof, and the like, including, for example, 1,6-hexanedioldiacrylate, trimethylolpropanetriacrylate, hexanedioldivinylether, triethyleneglycoldiacrylate, pentaerithritoltriacrylate, tripropyleneglycol diacrylate, alkoxylated bisphenol A diacrylate, and combinations thereof.

Suitable examples of monomer diluents also include, but are not limited to, aromatic-containing monomers such as phenoxyalkyl acrylates or methacrylates (e.g., phenoxyethyl(meth)acrylate), phenoxyalkyl alkoxylate acrylates or methacrylates (e.g., phenoxyethyl ethoxylate (meth)acrylate or phenoxyethyl propoxylate(meth)acrylate), or one of any other such monomer diluents suitable for use with such compositions, Combinations including one or more of these are suitable as well. Such monomer diluents belonging to the latter category are disclosed and described in U.S. Pat. No. 5,146,531 and may, for example, contain (1) an aromatic moiety; (2) a moiety providing a reactive (e.g., acrylic or methacrylic) group; and (3) a hydrocarbon moiety.

Examples of aromatic monomer diluents additionally containing hydrocarbon character and a vinyl group include but are not limited to polyalkylene glycol nonylphenylether acrylates such as polyethylene glycol nonylphenylether acrylate or polypropylene glycol nonylphenylether acrylate, polyalkylene glycol nonylphenylether methacrylates such as polyethylene glycol nonylphenylether methacrylate or polypropylene glycol nonylphenylether methacrylate, alkoxylated nonylphenol acrylates such as ethoxylated nonyl phenol acrylate, and mixtures of these.

Such monomers are, for example, available from Toagasei Chemical Industry Company, Ltd., Tokyo, Japan under the trade names ARONIX M111, M113, M114 and M117; Henkel Corporation, Ambler, Pa., under the trade name PHOTOMER 4003; and Sartomer under the tradename SR-504.

Other suitable monomer diluents additionally include hydrocarbon alkyl acrylates or methacrylates which are either straight chain or branched, and may contain 2 to 18 carbon atoms in the alkyl moiety including, for example, hexyl acrylate, hexyl methacrylate ethylhexyl acrylate, ethylhexyl methacrylate, isooctyl methacrylate, octyl acrylate, octyl methacrylate, decyl acrylate, decyl methacrylate, isodecyl acrylate, isodecyl methacrylate, lauryl acrylate, lauryl methacrylate, tridecyl acrylate tridecyl methacrylate, palmitic acrylate palmitic methacrylate, stearyl acrylate, stearyl methacrylate, cetyl acrylate, cetyl methacrylate, C14-C15, hydrocarbon diol diacrylates, C14-C15 hydrocarbon diol dimethacrylates, and mixtures of the above. Of these, octyl, decyl, isodecyl and tridecyl acrylates are particularly useful in certain embodiments.

Also suitable are cyclic monomers such as isobornyl acrylate, isobornyl methacrylate, dicyclopentenyl acrylate, dicyclopentenyl methacrylate, dicyclopentenyl ethoxylate acrylate, dicyclopentenyl ethoxylate methacrylate, tetrahydrofurfuryl acrylate, tetrahydrofurfuryl methacrylate, and mixtures thereof.

If the radiation-curable functional group of the low molecular weight polymer is an epoxy group, for example, one or more of the following compounds may be used, or additionally used, as the monomer diluent: epoxy-cyclohexane, phenylepoxyethane, 1,2-epoxy-4-vinylcyclohexane glycidylacrylate, 1,2-epoxy-4-epoxyethyl-cyclohexane, the diglycidylether of polyethylene-glycol, the diglycidylether of bisphenol-A, and the like.

If the radiation-curable functional group of the low molecular weight polymer has an amine-ene or thiol-ene system, examples of monomer diluents having allylic unsaturation may be used, or additionally used, which include: diallylphthalate, triallyltri-mellitate, triallylcyanurate, triallylisocyanurate, and diallylisophthalate. For amine-ene systems, amine functional diluents that can be used include, for example: the adduct of trimethylolpropane, and di(m)ethylethanolamine, the adduct of hexanediol, and dipropylethanolamine, and the adduct of trimethylol propane, and di(m)ethylethanolamine.

It will be appreciated any one or more of these types of monomer diluents may be used including mixtures comprising these diluents and systems with diluents mixed with other oligomers.

### Acrylic Acid

The compositions also comprise acrylic acid. Acrylic acid is available commercially from a wide array of suppliers and sources.

### Photoinitators

The compositions additionally comprise one or more photoinitiators. A photoinitiator refers to any compound that, by exposure to electromagnetic radiation, undergoes a photoreaction producing one or more reactive species. These reactive species are capable of initiating the polymerization or reaction of other polymerizable compounds within the composition, and may include, for example free radical species and cationic species. In general, most free radical photoinitiators are reactive to UV radiation having a wavelength between 200 to 400 nm, but some free radical species have been developed to react to radiation in the IR range. Certain cationic photoinitiators produce Brönsted or Lewis acids and can be activated by exposure to UV or electron beam radiation. In certain embodiments of the present subject matter, a photoinitiator polymerizes one or both of the low molecular weight polymer and the monomer diluents. Exemplary photoinitiators useful for polymerizing components in the composition include acetophenones, aryl phosphineoxides, aryl sulfonium and aryl iodonium salts of hexafluorophosphate, benzyl/benzoins, benzopheneones, thioxanthones, onium salts, and combinations thereof. Suitable free radical photoinitiators can include benzoins ethers, such as benzoin methyl ether or benzoin isopropyl ether, substituted benzoin ethers, such as anisoin methyl ether, substituted acetophenones, such as 2,2-diethoxyacetophenone and 2,2-dimethoxy-2-phenylacetophenone substituted alpha-ketols, such as 2-methyl-2-hydroxypropiophenone aromatic sulfonyl chlorides, such as 2-naphthalene-sulfonyl chloride, and photoactive oximes, such as 1-phenyl-1,2-propanedione-2(O-ethoxycarbonyl)oxime. Free radical photoinitiators for use in the compositions of the present subject matter include, but are not limited to, commercially available compounds such as IRGACURE 651 and 819 from CIBA Specialty Chemicals Corp.; Tarrytown, N.J. An exemplary cationic photoinitiator which is commercially available includes [4-[(2-Hydroxytetradecyl)oxy]phenyl]phenyliodium hexafluoroantimoate from Aldrich Chemical Company, Milwaukee, Wis.

The photoinitiator is used in a small but effective amount to promote radiation cure, in certain embodiments and should provide reasonable cure speed without causing premature gelation of the composition. Still further, the photoinitiator should itself be thermally stable, non-yellowing, and efficient.

Suitable photoinitiators include, but are not limited to, the following: hydroxycyclohexylphenyl ketone, hydroxymethyl-phenylpropanone dimethoxyphenylacetophenone, 2-methyl-1-4-methyl (thio)phenyl-2-morpholino-propanone-1,1-(4-isopropylphenyl)-2-hydroxy-2-methylpropan-1-one, 1-(4-dodecylphenyl)-2-hydroxy-2-methylpropan-1-one, 4-(2-hydroxyethoxy)phenyl-(2-hydroxy-2-propyl)ketone, diethyoxyacetophenone, 2,2 di-sec-butoxyacetophenone, diethoxy-phenyl acetophenone, and mixtures of these.

In certain embodiments, a particular class of photoinitiators are the triacylphospine oxides, such as trimethylbenzoyldiphenylphosphine oxide (available from BASF Corp., Chemicals Division, Charlotte, N.C. as LUCIRIN TPO) trimethylbenzoylethoxyphenylphosphine oxide (available from BASF as LUCIRIN 8893); bis-(2,5-dimethoxybenzoyl)-2,4,4-trimethylpentyl phosphine oxide (available from Ciba-Geigy Corp., Ardseley, N.Y.); and mixtures thereof.

The photoinitiator, when used, should be used at a level such that a cure speed, as measured in a dose versus modulus curve, of less than 0.7 J/cm², and particularly less than 0.5 J/cm², is obtained. Typically, the composition will comprise from 0.5 to 10.00 wt. % of photoinitiator. In certain embodiments, the amount of photoinitiator is from 1.0 to 8.0 wt. %.

### Crosslinkers

The compositions may also comprise one or more crosslinkers. A crosslinking agent as referred to herein is any substance that promotes or regulates intermolecular covalent bonding between acrylic copolymer chains, linking them together to create a more rigid structure. Exemplary crosslinking agents useful for polymerizing acrylic polymers, copolymers, and/or include amino resins, aziridines, melamines, isocyanates, metal acid esters, metal chelates, multifunctional propylene imines, and polycarbodimides. In particular embodiments of the present subject matter, the crosslinking agent includes metal acid esters comprising aluminum(III) acetylacetonate (AlAcAc), chromium(III) acetylacetonate (CrAcAc), iron(III) acetylacetonate (FeAcAc), cobalt(II) acetylacetonate (CoAcAc), nickel(II) acetylacetonate (NiAcAc), manganese(III) acetylacetonate (MnAcAc), titanium(IV) acetylacetonate (TiAcAc), zinc(II) acetylacetonate (ZnAcAc), zirconium(IV) acetylacetonate (ZrAcAc), and combinations thereof. In a certain embodiment, the crosslinking agent is aluminum (III) acetylacetonate (AlAcAc). The crosslinking agent may be added as a separate component during fabrication of the compositions or may have been previously incorporated into the acrylic copolymer by a supplier of the same.

The composition may optionally include numerous other suitable additives depending on the particulars of the application for which the composition is designed. Any additives used may be introduced into the composition in effective amounts. The total amount of additives present is typically between 0 and 30 wt % and more particularly from about 1 wt % to about 25 wt %. For example, slip agents may be used to reduce the coefficient of friction and thermal antioxidants may be used to improve oxidation and thermal stability. Silane coupling agents may be used to improve adhesion between, for example, the cured composition and an optical fiber surface. Other additives include stabilizers to prevent gellation, UV screening compounds, leveling agents, polymerization inhibitors, light stabilizers, chain transfer agents, colorants including pigments and dyes, plasticizers, fillers, tackifiers, wetting improvers, preservatives, and the like. Other polymers and oligomers can be added to the compositions.

As previously noted, the compositions of the present subject matter are typically solvent free. If the composition contains solvent, the solvent can be removed prior to at least one of the curing operations, i.e., the first stage UV cure or the second stage EB cure. Generally, the initial composition subjected to the first stage UV cure is solvent free. The terms “solvent free” or “free of solvents” as used herein refer to compositions which do not contain any solvent(s), or if containing solvent, has a total amount of solvent that is less than 2%, particularly less than 1%, more particularly less than 0.5%, and more particularly less than 0.1% by weight.

### Methods

The term “curing” as used herein is typically used as a synonym for crosslinking but can also refer to a combination of additional polymerization reaction plus crosslinking. Curing of crosslinkable adhesive compositions, particularly, acrylic based adhesives may be accomplished generally by thermal, chemical and/or radiation crosslinking techniques. In general, thermal crosslinking includes evaporation or drying of a solvent or dispersant from the adhesive composition. Thermal crosslinking may further include a chemical crosslinking reaction involving the use of one or more crosslinking agents which are activated by the evaporation of solvent from the adhesive composition. The acrylic copolymer may undergo thermal and/or chemical induced crosslinking reactions during a first curing stage by evaporation of a solvent of the adhesive composition. Radiation crosslinking techniques include exposure to electromagnetic radiation of any frequency and particularly include infrared (IR) radiation, visible light ultraviolet (UV) radiation, X-rays and gamma rays. Radiation crosslinking also includes exposure to sunlight.

Generally, in accordance with the present subject matter, the acrylic copolymer undergoes radiation induced crosslinking reaction during the first curing stage by exposure to UV radiation and more particularly UV radiation having a wavelength within a range of from about 200 nm to about 500 nm. In many embodiments of the present subject matter, the crosslinkable low molecular weight polymer and/or monomer diluent(s) undergo a radiation induced crosslinking reaction during a first curing stage by exposure to UV radiation from a UV bulb or sunlight, particularly, UV radiation having a wavelength of least 200 nm, more particularly by UV radiation having a wavelength of between 300 to 500 nm, and most particularly by UV radiation having a wavelength of between 320 to 380 nm.

Typically, exposure to UV radiation to achieve the first stage of the dual stage cure of the present subject matter, is performed for a time period of from about 1 minute or less up to about 300 minutes or longer, as is desired. For many applications, exposure to UV radiation is for a time period from 1 minute to 30 minutes, and particularly from 1 minute to 10 minutes. However, it will be appreciated that the present subject matter includes time periods shorter than and/or longer than those noted herein.

As previously noted, the present subject matter utilizes a second stage cure that includes electron beam curing. Electron beam curing is a very fast, non-thermal curing method that uses high energy electrons and/or X-rays as ionizing radiation at controlled rates to cure radiation sensitive resins such as those used in adhesives and polymer matrix composites. Subject to well understood physical relationships governing radiation penetration through materials, this curing takes place throughout the entire volume of the exposed material versus thermal curing in which the heat energy diffuses through the material from the heated surface. In electron beam curing, the cross-linking reactions take place very rapidly and the degree of cure is more closely related to the absorbed radiation than to the temperature achieved in the process, as in thermal curing. Without exposure to high temperatures, radiation, or excessive light, the electron beam curable materials do not appreciably autocure. This characteristic makes storage, cleanup of excess materials, and other handling practices simpler.

In certain embodiments, the compositions formed including additives may be coated on any suitable substrate such as face stock, release liner stock or transfer surfaces by means known in the art. After exposure to UV radiation to effect a first cure or partial cure, the coating(s) is exposed to electron-beam radiation at levels sufficient to increase high temperature properties, particularly shear, without adversely affecting peel and tack at normal use temperatures. Electron beam dosages may range from about 10 kiloGray (kGy) or less up to about 100 kGy, and preferably 50 kGy or less depending on the nature of the polymer and amount of additives present, with required dosages being lowered by the presence of any multifunctional additives. The presence of a multifunctional additive can also create a limit on the EB dosages used. A peak is reached at some level after which the level of increase of elevated temperature shear will be reduced but still be above the level which existed prior to cure.

Typically, exposure to EB radiation to achieve the second stage of the dual stage cure of the present subject matter, is performed for a time period of from about 1 minute or less up to about 300 minutes or longer, as is desired. For many applications, exposure to EB radiation is for a time period from 1 minute to 30 minutes, and particularly from 1 minute to 10 minutes. However, it will be appreciated that the present subject matter includes time periods shorter and/or longer than those noted herein.

### Cured Materials

The present subject matter also provides polymeric materials and particularly acrylate materials or acrylate-based materials which are at least partially cured from sequential exposure to UV radiation followed by EB radiation. The cured materials are formed from the compositions as described herein, and curing such compositions via the dual stage cure strategy as described herein.

In a representative application, the present subject matter includes applying the composition such as by coating, to a film substrate. The coated composition is then subjected to a first stage cure by exposure to UV radiation such that the coated composition can be wound up in a roll and be relatively stable, e.g., not exhibit significant flow. After the UV curing increases the molecular weight and extent of crosslinking to a stable point, the roll can be unwound or otherwise processed through an electron beam unit, to thereby complete crosslinking and curing.

In several trials, compositions as described herein exhibited significant increases in shear after the dual stage curing process described herein.

Many other benefits will no doubt become apparent from future application and development of this technology.

All patents, published applications, and articles noted herein are hereby incorporated by reference in their entirety.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

1. A method of forming a cured polymeric material, the method comprising:
providing a polymeric composition;
exposing the composition to ultraviolet (UV) radiation to thereby form an intermediate composition;
exposing the intermediate composition to electron beam (EB) radiation to thereby form a cured polymeric material.

2. The method of claim 1 wherein the UV radiation has a wavelength within a range of from 200 nm to 500 nm.

3. The method of claim 1 wherein the UV radiation has a wavelength within a range of from 300 nm to 500 nm.

4. The method of claim 1 wherein the electron beam radiation is at a dosage of less than 10 kiloGray.

5. The method of claim 1 wherein the electron beam radiation is at a dosage within a range of from 10 kiloGray to 100 kiloGray.

6. The method of claim 1 wherein the polymeric composition comprises (i) at least one low molecular weight polymer, (ii) at least one monomer diluent, (iii) acrylic acid, and (iv) at least one photoinitiator.

7. The method of claim 6 wherein the composition further comprises at least one crosslinker.

8. The method of claim 1 wherein the composition is free of solvents.

9. The method of claim 6 wherein the low molecular weight polymer is a crosslinkable acrylate polymer.

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)
